(19) United States
(12) Patent Application Publication
(10) Pub. No.: US 2016/0096135 A1
(43) Pub. Date: Apr. 7, 2016

(54) DOOR ASSEMBLY WITH SCANNING MECHANISM, AND CONTAINMENT SYSTEM WITH SAME

(71) Applicant: CAMFIL USA, INC., Riverdale, NJ (US)

(72) Inventor: Keith G. WOOLARD, Washington, NC (US)

(21) Appl. No.: 14/869,249

(22) Filed: Sep. 29, 2015

Related U.S. Application Data
(60) Provisional application No. 62/059,845, filed on Oct. 3, 2014.

(51) Int. Cl. B01D 46/00; F24F 3/16; G01M 3/26; F24F 13/02

(52) U.S. Cl. CPC B01D 46/0091; F24F 13/029; F24F 3/161; B01D 46/0086; G01M 3/26

(57) ABSTRACT

An access door that includes a scanning mechanism for a containment system, a containment system having the same, and a method for leak testing a filter installed in the containment system are described herein. In one embodiment, a containment system is disclosed that includes a housing having a downstream test section access port selectively sealed by a downstream test section access door. A displacement assembly is coupled to the downstream test section access door and is operable to move a plurality of probes disposed in the housing relative to the test section access door.

### CROSS-REFERENCE TO RELATED APPLICATIONS

This application claims benefit of U.S. Provisional Application Ser. No. 62/059,845, filed Oct. 3, 2014 (Attorney Docket No. CMFL/115USL), of which is incorporated by reference in its entirety.

### BACKGROUND

1. Field

The invention generally relates to an access door that includes a scanning mechanism for a containment system, a containment system having the same, and a method for leak testing a filter installed in the containment system.

2. Description of the Related Art

Containment systems are relied upon in lab testing the most toxic and virulent chemicals, agents, viruses, and organisms, each potential leak point represents a source for a potential catastrophic biohazard release that could expose technicians and/or the surrounding environment.

FIG. 1 depicts a conventional containment system 100 having an inlet 124 and an outlet 126. The conventional containment system generally consists of multiple components arranged in series in a housing 102. The components in the housing 102 generally include a filter 106, a scanning mechanism 108, an upstream section 110, and a downstream test section 112. The containment system 100 also includes a downstream test section access door 116 and a filter access door 118. The access filter door 118 may be opened to replace the filter 106 disposed in the housing 102. The downstream test section access door 116 (shown in an open position) may be removed to allow access to the downstream side of the filter 106 for testing. The access doors 116, 118 may be closed to sealingly isolate the interior of the housing 102 from the surrounding environment when the containment system 100 is in use.

Isolation dampers 114 are located upstream and downstream of the housing 102, the upstream section 110, and downstream test section 112. The dampers 114 allow the containment system 100 to be sealed air-tight during system decontamination. Transitions 120 are disposed between the isolation dampers 114 and other components of the containment system 100 to improve airflow. The dampers 114 may be bolted or welded to the transitions 120. Additional ductwork 122 may be disposed between the dampers 114 and the transitions 120.

The upstream section 110 is utilized for the introduction of an aerosol challenge upstream of the filter 106 and for the measurement of upstream challenge concentration. Conventional upstream sections 110 typically include baffles to achieve adequate aerosol mixing such that testing may be performed to ANSI, IEST or other standard. The filter 106 disposed in the housing 102 may be an intermediate efficiency filter, a HEPA filter, HEGA filter and/or filter selected for a specific application. It is contemplated that the filter 106 may be a panel filter, v-bank filter or other type of filter configuration.

The downstream test section 112 is access the downstream side of the filter 106 for conduct scan testing and validation of the HEPA filter(s) to determine the location and size of any leaks in the filter(s). With the downstream test section access door 116 removed, a technician may access to the downstream side of the filter 106 for testing. For example, the technician may to manually scan the filter 106 with a probe 108 coupled to test equipment 130, such as a photometer, particle counter or other suitable filter leak or efficiency testing device, through the downstream test section 112 when the downstream test section access door 116 is removed.

A bio-isolation bag with integral gloves (not shown) is generally coupled to a bagging ring 132 extending outward from the housing 102. The test section access door 116 encloses the bagging ring 132 when sealing the downstream test section 112. The bio-isolation bag, manufactured from PVC or other suitable material, has an opening containing an elastic cord or o-ring that is capable of stretching sufficiently to slide over the outside circumference of the bagging ring 132. The cord fits securely against the bagging ring and keeps the bag attached to the containment system 100. The bag essentially forms a boundary between the contaminated interior of the containment system and technicians performing service work from the exterior of the housing 102. The bag may be utilized to position the probe 108 during testing of the filter 106 disposed in the containment system 100.

However, each time the downstream test section access door 116 is opened to test the filter 106, the risk for potential exposure of biohazards within the housing 102 increased. Additionally, installation of a new integrated automatic scanning mechanism is very costly. Moreover, upgrading from a manual bag with gloves to an automated integrated scanning probe 108 permanently disposed in the housing 102 may require replacement of the entire containment system 100.

Thus, there is a need for an improved method of scanning the filter of a containment system without risk of exposure to contaminants, and for an improved apparatus for scanning a filter in a containment system.

### SUMMARY

An access door that includes a scanning mechanism for a containment system, a containment system having the same, and a method for leak testing a filter installed in the containment system are described herein. In one embodiment, a containment system is disclosed that includes a housing having a downstream test section access port selectively sealed by a downstream test section access door. A displacement assembly is coupled to the downstream test section access door and is operable to move a plurality of probes disposed in the housing relative to the test section access door.

In another embodiment, a downstream test section access door is provided that includes a door assembly configured to selectively seal a containment system access port. A displacement assembly is coupled to the test section access door. The displacement assembly is operable to move a plurality of probes configured to obtain air samples relative to the test section access door.

In yet another embodiment, a method for testing a filter disposed in a containment system is provided that includes flowing air into the containment system and through a filter disposed in the containment system, and scanning the filter with a plurality of probes mounted to a door of the containment housing.

In still another embodiment, a containment system is provided that includes a housing configured to hold a filter in a position that separates an upstream section from a downstream test section. The housing includes a filter access port for replacing a filter disposed in the housing, and downstream test section access port communicating with the downstream test section. A downstream test section access door is provided that is configured to selectively seal the downstream test section access port. A displacement assembly is disposed in the housing. A plurality of probes are disposed in the downstream test section which are non-intrusively displaceable by the displacement assembly. A filter access door is provided that is configured to selectively seal the filter access port. A plurality of sample ports are formed through the downstream test section access door. The sample ports are coupled to the probes by tubing.

### BRIEF DESCRIPTION OF THE DRAWINGS

The accompanying drawings, which are incorporated in and constitute a part of the specification, schematically illustrate the present invention and, together with the general description given above and the detailed description given below, serve to explain the principles of the invention

FIG. 1 is a partial cut away top view of a conventional containment system;

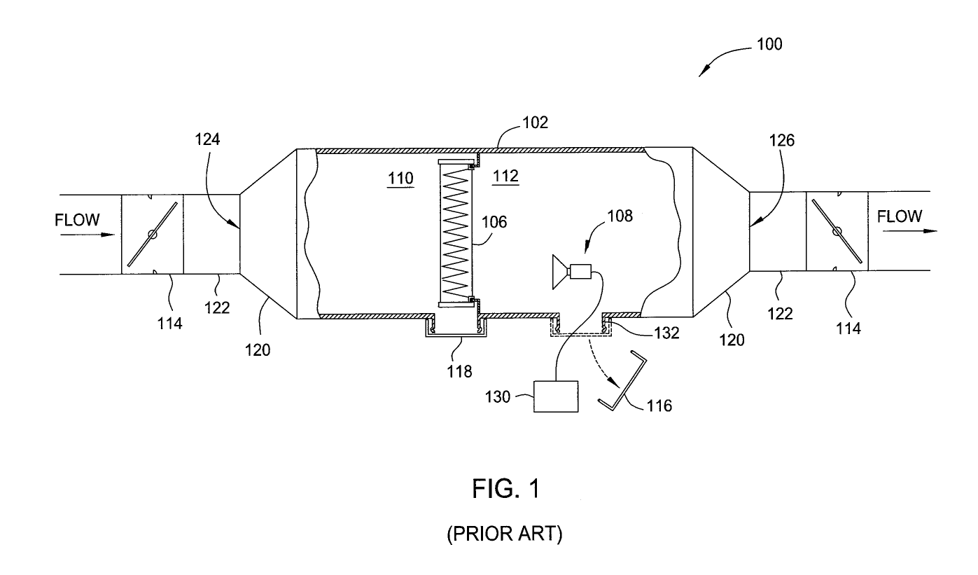

FIG. 2 is a partial cut away top view of one embodiment of a containment system;

FIG. 3 is a sectional side view of one embodiment of the downstream test section access door; and

FIG. 4 is a sectional side view of another embodiment of the downstream test section access door.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION

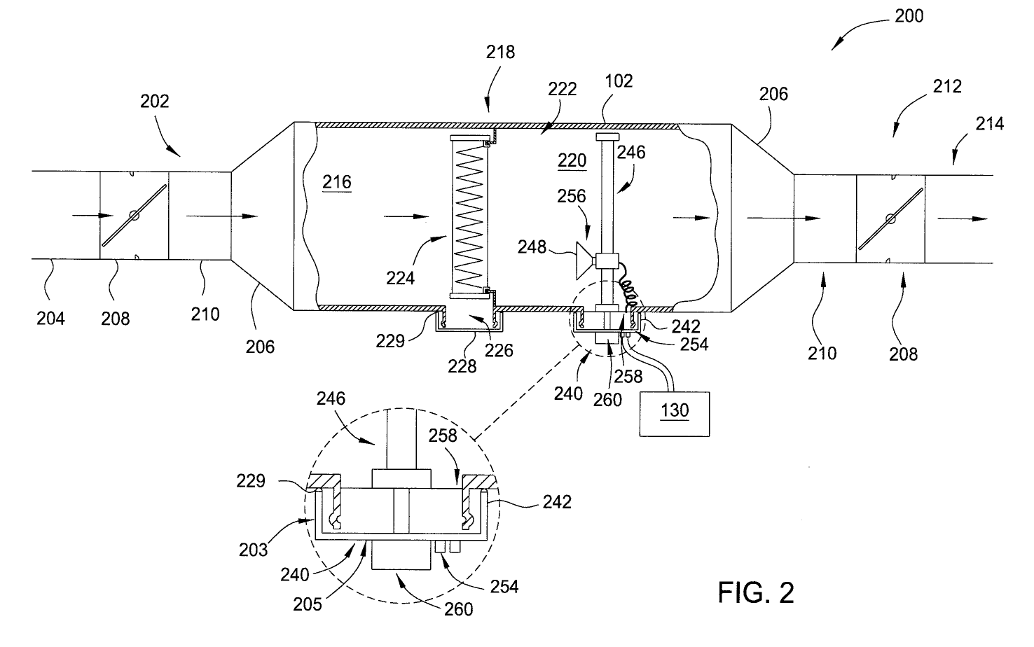

FIG. 2 is one embodiment of a containment system 200 having a housing 280 to which the downstream test section access door assembly 240 is mounted. A conventional containment system, such as the containment system 100 described above, may be retrofitted to become the containment system 200 by replacing the downstream test section access door 116 with the downstream test section access door assembly 240, the advantages of which are described below.

The housing 280 includes an upstream section 216, a filter section 218, and a downstream test section 220. The upstream section 216 is separated from the downstream test section 220 by the filter section 218. The upstream section 216 is connected to upstream ductwork 202. The upstream ductwork 202 may include an air inlet duct 204, a transition 206, a damper 208, and optional ductwork 210 connecting the damper 208 to the transition 206. The downstream test section 220 is connected to downstream ductwork 212. The downstream ductwork 212 comprises an air outlet duct 214, a transition 206, a damper 208, and optional ductwork 210. Optional ductwork 210 may connect the damper 208 to the transition 206. The dampers 208, located in both the upstream ductwork 202 and the downstream ductwork 212 of the housing 280 allow the containment system 200 to be sealed air-tight at the air inlet duct 204 and the air outlet duct 214 of the containment system 200 during system decontamination. The dampers 208 may be welded or bolted to the transitions 206.

The upstream ductwork 202 is utilized during normal filtering operations to allow unfiltered air to enter the containment system 200. Once the air flows into the upstream ductwork 202, it passes through the upstream section 216 and into the filter section 218. The filter section 218 includes a filter holder 222 adjacent to a filter access port 226. The filter holder 222 is configured to hold and seal a filter 224 to the filter section 218 in a manner that causes air flowing through the housing 280 to flow through the filter 224.

The filter 224 may be accessed through the filter access port 226, which is selectively sealed by a filter access door 228 and a sealing member 229 disposed on a distal end of a lip extending from and circumscribing a plate of the door 228. The sealing member 229 may be a gasket, an o-ring, or other suitable seal. The filter access door 228 may be opened to replace the filter 224 disposed in the housing 280 to facilitate testing of the filter 224 in the containment system 200. The filter 224 may be a HEPA filter or any other suitable filter for use in a containment system 200. It is contemplated that the filter 224 may be a panel filter, v-bank filter, or other type of filter configuration.

After the air flows into the upstream section 216, the air moves through the filter 224, and into the downstream test section 220. The downstream test section 220 comprises a downstream test section access port 258. The downstream test section access port 258 may be selectively sealed by a downstream test section access door 203 of the door assembly 240. The downstream test section access door 203 of the door assembly 240 includes a plate 205 having a circumscribing lip 242. The circumscribing lip 242 is generally long enough to provide clearance for a bagging ring 132 extending from the downstream test section access port 258 of the downstream test section 220. A sealing member 229 is disposed on a distal end of the lip 242 to provide a seal between the door 203 and the downstream test section 220.

The door assembly 240 also includes a displacement assembly 246 and one or more sample ports 254. The displacement assembly 246 is coupled to a scanning mechanism 256. The displacement assembly 246 is operable to move one or more probes 248 of the scanning mechanism 256. Although only a single probe 248 is shown in FIG. 2, a plurality of probes 248 may be utilized, for example, arranged in a linear row to allow complete scanning of the filter 224 in a single pass of the scanning mechanism 256. The displacement assembly 246 may be configured to allow manual displacement of the probes 248 of the scanning mechanism 256 from the exterior of the housing 280, and thus, without opening the access door 203 of the door assembly 240 and exposing technicians to potential hazards which may be entrained in the air passing through the containment system 200. Alternatively, the displacement assembly 246 may be configured to allow automatic displacement of the probes 248 of the scanning mechanism 256, such as with the use of actuators, motors or robots and the like, without accessing the interior of the housing 280.

The probes 248 are generally configured to allow isokinetic sampling at a predefined filter test velocity. The number and size of the probes 248, along with the range of motion provided by the scanning mechanism 256, are selected to enable the probes 248 to scans the entire downstream face of the filter 224. Accordingly, the probes 248

The probes 248 are coupled to the sample ports 254 so that samples of the air passing through the filter 224 into the downstream test section 220 may be tested to determine if pinhole leaks are present in the filter 224. The probes 248, via the sample ports 254, may be connected to a photometer, particle counter, or other suitable filter testing device 130.

As discussed above, the downstream test section access door assembly 240 may be utilized as a retrofit door kit that will convert a housing 102 of a conventional containment system 100 into a containment system 200 having automatic or non-intrusive manual scanning capabilities. Alternatively, the containment system 200 may include the probe assess door assembly 240 as original equipment direct from a manufacturer or distributor.

As described above, the displacement assembly 246 may be a non-intrusive automatic device configured to displace the probes 248 in a predetermined and/or programmable motion. In another embodiment, the displacement assembly 246 may be a non-intrusive manual assembly configured to displace the probes 248 via manually operated mechanisms. Controls and/or utilities for the displacement assembly 246 may be routed through one or more of the sample ports 254 defined through the door assembly 240 to a control mechanism 260.

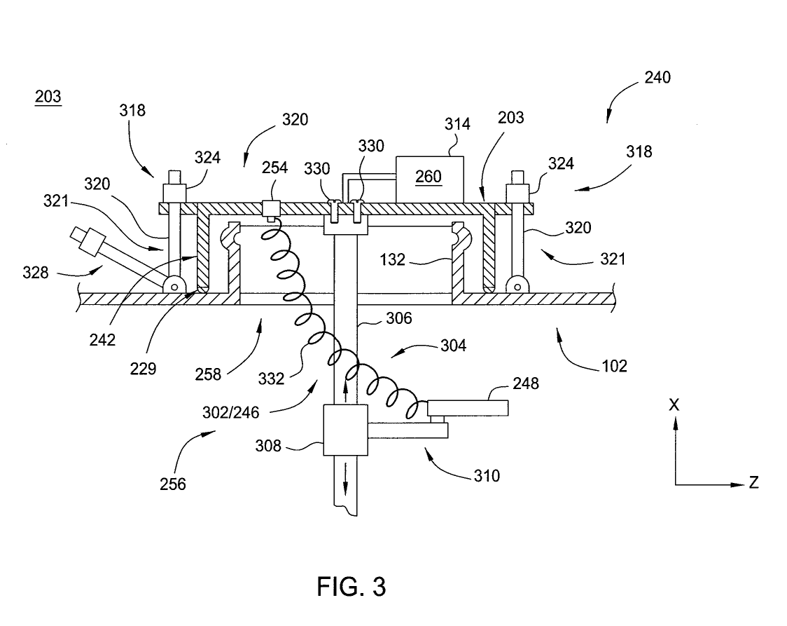

Referring now primarily to the sectional side view of FIG. 3, the door assembly 240 is illustrated with the displacement assembly 246 in the form of an automatic displacement assembly 302, and the control mechanism 260 in the form of an automatic control mechanism 314. The door assembly 240 is shown installed closing the downstream test section access port 258 of a containment system 200. The door assembly 240 may be removably secured to the containment system 200 by a locking mechanism 318. The locking mechanism 318 may be any suitable mechanism, and in one example, the locking mechanism 318 includes a threaded stud 320 and a star nut 324. The threaded stud 320 may be pivotally mounted to the containment system 200. The door assembly 240 is secured over the downstream test section access port 258 of the containment system when the locking mechanism 318 is oriented in a locking position 321 which engages the threaded stud 320 with the door assembly 240, allowing the star nut 324 to be turned to a position that compresses the sealing member 229 sealing the door 203 over the port 258. The door assembly 240 may be removed by orienting the locking mechanism 318 into an open position 328 (shown in phantom) by loosening the star nut 324 to allow the threaded stud 320 to be moved clear of the door 203, thus allowing the door 203 to be move clear of the port 258.

The automatic displacement assembly 302 is coupled to the door 203 of the door assembly 240 such with the door 203 and automatic displacement assembly 302 form an integral assembly that may be readily removed from the housing 280. For example, the door assembly 240 may be fastened to the door assembly 240 in a cantilevered or other manner, for example, using bolts 330. The automatic displacement assembly 302 alternatively may be coupled to an intermediary base member (not shown), with the base member then connected to the door assembly 240.

The automatic displacement assembly 302 comprises a motion mechanism 304. The motion mechanism 304 may comprise one or more of any suitable actuator, robot, X/Y actuator, linear actuator, a stepper or servo motor, a fluid power cylinder, a rod-less cylinder, a chain or belt drive, a rack and pinion gear arrangement, a ball screw, lead screw, acme screw, or other power screw, or other suitable motion generating and/or motion facilitating mechanism.

The motion mechanism 304 shown in FIG. 3 comprises an actuator 306, such as a rod-less cylinder. The actuator 306 may have a carriage 308 slideably coupled thereto. The position of the carriage 308 controllably moved along the actuator 306 utilizing a motor, air, hydraulic or other motion control. The carriage 308 is coupled to a scanning mechanism 310. The carriage 308 generally has a range of motion sufficient to ensure the scanning mechanism 310 can cover the width of the filter 224 to effectively scan the filter 224. The carriage 308 may be controlled by an automatic control mechanism 314, such as a motor, which is shown as mounted to an exterior of the door assembly 240. However, the automatic control mechanism 314 may alternatively be mounted within the containment system 200. The scanning mechanism 310 is comprised of a plurality of probes 248 for scanning the entire face of the filter 224.

The position of the probes 248 is controlled by an automatic control mechanism 314. The automatic control mechanism 314 may be attached to an exterior 320 of the door assembly 240 or the housing 280. By controlling the motion of the carriage 308, the probes 248 may be selectively positioned to scan the face of the filter 224. The motion mechanism 304 may move in only the X-direction, across the width of the filter 224 utilizing a plurality of probes 248 connected to the carriage 308. The motion mechanism 304 may, alternatively, make use of a single probe 248 and move in both the X and Y directions to effectively scan the filter 224.

The probes 248 are fluidly coupled to respective sample ports 254 by individual tubes 332, one of which is shown in FIG. 3. The tube 332 is shown to be coiled so that there is slack to allow for motion. The sample port 312 may be coupled to test equipment 130 (as shown in FIG. 2) to provide samples that may be utilized to determine when a leak is detected in the filter 224. The sample port 312 is configured to prevent leakage through the door assembly 240 when not in use. For example, the sample port 312 may include a quick disconnect or other suitable fitting, a check valve, isolation valve or other device to prevent inadvertent leakage through the door 203. The coupling of the automatic displacement assembly 302 to the door assembly 240 allows for easy installation of a scanning mechanism into a conventional containment system, thereby converting the conventional containment system into a containment system 200 with non-intrusive scanning capabilities.

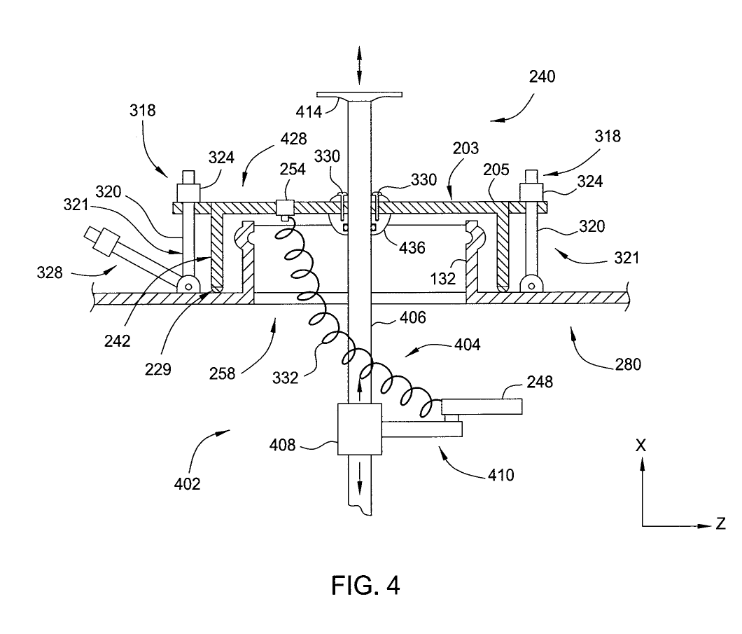

FIG. 4 is a sectional side view of the door assembly 240 having the displacement assembly 246 in the form of a manually operated displacement assembly 402. The door assembly 240 having the manually operated displacement assembly 402 may be incorporated into a pre-existing containment system or the containment system 200. The door assembly 240 is illustrated installed over the downstream test section access port 258 of the containment system 200. The door assembly 240 is secured to the containment system 200 by, for example, using a locking mechanism 318. The locking mechanism 318 may be configured as described above.

The manual displacement assembly 402 coupled to the door 203 of the door assembly 240 generally as described above with reference to the displacement assembly 302, for example utilizing bolts 330. The manual displacement assembly 402 alternatively may be cantilevered to a base member (not shown), the base member which is then connected to the door assembly 240.

The manual displacement assembly 402 comprises a motion mechanism 404 which is operable to move the probes 426 without opening the door 203. In one embodiment, the motion mechanism 404 sealably penetrates the plate 205 of the door 203 through a bearing 436. The bearing 436 allow a rod 406 of the motion mechanism 404 to move axially. A handle 414 may be coupled to the rod 406 to provide an interface for a technician to more easily and precisely operate (i.e., displace) the probes 248 using the rod 406.

The rod 406 has the scanning mechanism 410 fixed thereto. Thus, as the rod 406 is displaced axially, the scanning mechanism 410 also moves axially. The probes 248 are coupled to the scanning mechanism 410. Although a single probe 248 is shown in FIG. 4, multiple probes 248 may be utilized as described above. The rod 406 having the scanning mechanism 410 coupled thereto has sufficient range of motion to enable the probe(s) 248 to scan the downstream face the filter 224 to effectively scan the filter 224.

Thus, the position of the probes 426 is controlled from the exterior of the door assembly 240 using the portion of the rod 406 that extends through the door 203. Although the motion mechanism 404 is illustrated as a slideable rod 406, the manual motion mechanism 404 may be in the form of a manually operated actuator, such as a ball or lead screw, which moves a carriage 408 in the X-direction to move the plurality of probes 248 across the filter 224. Alternatively, the manual displacement assembly 402 may move the probes 248 in both the X and Y directions to effectively scan the face of the filter 224. By controlling the motion of the carriage 408, the probes 426 may be selectively positioned to scan the face of the filter 224.

Referring back to FIG. 2, the filter 224 of the containment system 200 may be effectively tested using the motion mechanism 404 mounted to the door assembly 240. Testing may be accomplished by flowing aerosol laden air into the air inlet duct 204 of the upstream ductwork 202. The aerosol laden air then flows into the upstream section 216. Alternatively, aerosol may be introduced in to the air at other locations, for example within the upstream section 216. The aerosol laden air flows into the filter section 218 and through the filter 224. The filtered air exiting the filter 224 flows into the downstream test section 220. The probes 248 of the scanning mechanism 256 obtain samples of the air exiting the filter 224. The displacement assembly 246 actuates the scanning mechanism 256 to appropriately position probes 248 to effectively scan the entire downstream face of the filter 224. The displacement of the probes 248 may be accomplished utilizing the automatic control mechanism 314 described with reference to FIG. 3 or by utilizing the manual displacement assembly 402 described with reference to FIG. 4, all without opening the door 203 of the door assembly 240. The samples obtained by the probes 248 are provided to the test equipment 130 to determine if leaks are present in the filter 224. Although not shown, samples of the air upstream of the filter 224 are also provided to the test equipment 130 in order to determine the aerosol concentration so that a leak threshold may be established.

In other embodiments, the displacement assembly 246 and scanning mechanism 256 may be coupled to the bagging ring 132 or to other locations within the housing 280. In other embodiment, the displacement assembly 246 and scanning mechanism 256 may include adjustable mounting elements to enable the displacement assembly 246 and scanning mechanism 256 to be passed through the filter access port 226 or downstream test section access port 258, and adjusted to a size that tightly fits across the sectional area of the downstream test section 220. In such embodiments, the sample ports 254 remain disposed through the door 203 of the door assembly 240 so that non-intrusive scanning capabilities may be added to convention containment systems without having to form additional holes through the housing 280 to facilitate coupling the probes 248 to the test equipment 130 without having to access the interior of the housing 280.

What is claimed is:

1. A containment system comprising:
a housing configured to hold a filter in a position that separates an upstream section from a downstream test section, the housing having a filter access port for replacing a filter disposed in the housing, the housing having a downstream test section access port formed in the housing communicating with the downstream test section;
a filter access door configured to selectively seal the filter access port;
a downstream test section access door configured to selectively seal the downstream test section access port;
a plurality of probes coupled to the downstream test section access door; and
a displacement assembly coupled to the downstream test section access door, the displacement assembly operable to move the probes relative to the test section access door.

2. The containment system of claim 1, wherein the displacement assembly is an automatic displacement assembly.

3. The containment system of claim 1, wherein the displacement assembly is a manual displacement assembly.

4. The containment system of claim 1, wherein the downstream test section access door further comprises sealing member to selectively seal the downstream test section access port.

5. The containment system of claim 1, wherein the housing further comprises a control mechanism for controlling the displacement assembly from outside the housing.

6. The containment system of claim 5, wherein the control mechanism is routed through a sample port defined through the downstream test section access door.

7. A downstream test section access door comprising:
a door assembly configured to selectively seal a containment system access port;
a plurality of probes configured to obtain air samples; and
a displacement assembly coupled to the test section access door, the displacement assembly operable to move the probes relative to the test section access door.

8. The downstream test section access door of claim 7 further comprising:
a plurality of sample ports formed through the downstream test section access door, the sample ports coupled to the probes.

9. The downstream test section access door of claim 8 further comprising:
a control mechanism attached to an exterior of the downstream test section access door, configured to operate the displacement assembly.

10. The downstream test section access door of claim 9, wherein the displacement assembly is an automatic displacement assembly.

11. The downstream test section access door of claim 9, wherein the displacement assembly is a manual displacement assembly.

12. A method for testing a filter disposed in a containment system, comprising:
flowing air into the containment system and through a filter disposed in the containment system; and
scanning the filter with a plurality of probes mounted to a door of the containment housing.

13. The method of claim 12 further comprising:
replacing a convention a door of the containment housing with the door having the plurality of probes coupled thereto.

14. The method of claim 12 further comprising:
routing samples obtained through the probes to test equipment through sample ports formed through the door.

15. The method of claim 12, wherein scanning the filter further comprises:
automatically moving the probes to scan the filter without opening the door.

16. The method of claim 12, wherein scanning the filter further comprises:
manually moving the probes to scan the filter without opening the door.

17. A containment system comprising:
a housing configured to hold a filter in a position that separates an upstream section from a downstream test section, the housing having a filter access port for replacing a filter disposed in the housing, the housing having a downstream test section access port formed in the housing communicating with the downstream test section;
a downstream test section access door configured to selectively seal the downstream test section access port;
a displacement assembly disposed in the housing;
a plurality of probes disposed in the downstream test section and non-intrusively displaceable by the displacement assembly;
a filter access door configured to selectively seal the filter access port;
a plurality of sample ports formed through the downstream test section access door, the sample ports coupled to the probes by tubing.

18. The containment system of claim 17, wherein the displacement assembly is coupled to the housing.

19. The containment system of claim 17, wherein the displacement assembly is adjustable to fit securely in the housing.
